(19) United States
(12) Patent Application Publication
(10) Pub. No.: US 2018/0007925 A1
(43) Pub. Date: Jan. 11, 2018

(54) POWDERED BEVERAGE COMPOSITIONS, SYSTEMS AND METHODS

(71) Applicant: 10th Avenue Tea LLC, La Grange, IL (US)

(72) Inventor: Ann E. FOLEY, La Grange, IL (US)

(21) Appl. No.: 15/207,098

(22) Filed: Jul. 11, 2016

(51) Int. Cl. A23F 3/40; B65D 83/06; A23F 3/06

(52) U.S. Cl. CPC A23F 3/405; A23F 3/06; B65D 83/06

(57) ABSTRACT

A dry, flowable beverage composition includes a tea mixture, the tea mixture including between about 60 percent and about 90 percent by weight of non-matcha tea and between about 10 percent and about 45 percent by weight of matcha tea. The non-matcha tea comprises a soluble, powdered tea extract. The beverage composition is substantially free of fillers. The disclosure also contemplates systems for producing a beverage as well as methods of producing a beverage.

### TECHNICAL FIELD

This disclosure relates to powdered tea compositions, systems and methods.

### BACKGROUND

Tea is the second most popular beverage in the world after water. Tea is available in many formats, e.g., as a hot beverage such as an infusion of black tea, green tea, or oolong tea in hot water. The consumer can prepare such an infusion from leaf tea, either loose or in a tea bag. Infusions take time to prepare properly, and it can be difficult to blend accurately different types of teas to produce a pleasing combination.

Alternatively, manufacturers have converted pre-infused tea concoctions into cold-instant tea or hot-instant tea powders. Some manufacturers use the above powders to form a beverage reconstituted by the consumer by the addition of the mixture to water. Instant tea is a product that contains no water insolubles. Hot instant tea products are fully soluble in hot water and can be consumed as such without filtration. A conventional process to prepare instant tea is described in the reference book Tea—Cultivation to Consumption, edited by K. C. Wilson & M. N. Clifford & published by Chapman & Hall (1992).

A typical process of manufacturing tea powder involves taking the desired raw material (e.g. black tea), which is extracted using hot water in a multi-stage counter-current extractor. The tea liquor/extract is separated from the spent tealeaf by passing it through a screw press. This extract, which typically contains about 3.5-4% tea solids, is clarified by removing coarse and fine particulates by deleafing in a centrifuge. When the hot extract is cooled, an insoluble phase separates which is known as cream. Processes are known which convert this insoluble cream fraction to a water-soluble fraction to improve extraction yields. Subsequently, the extract is concentrated to 35-40% solids in an evaporator. This concentrate is spray dried to get the instant tea powder. The preparation of instant tea compositions is involved and requires equipment not available to the average consumer.

Recent studies support current trends toward healthier living. This has had the effect of increasing consumer awareness about what constitutes a healthy diet and producing informed efforts toward making healthy eating and drinking choices. Since various health benefits have been attributed to the consumption of tea, tea remains a popular choice of the health-oriented consumer.

U.S. Patent Application Publication No. US 2008/0210714 is entitled, “Bulk Tea Dispensing System” and is directed to a bulk dispenser that dispenses a predetermined amount of a flowable material. The bulk dispenser may include a carton enclosed by a top assembly. An internal chimney extends into the carton and connects to the top assembly. The chimney is sized and positioned to dispense the predetermined amount of the flowable material.

There is a continued need in the art to provide additional beverage formulations. For example, there is a continued need for tea-based beverage compositions that appeal to current health conscious consumers by being eco-friendly, convenient, and natural.

It will be appreciated that this background description has been created by the inventor to aid the reader, and is not to be taken as an indication that any of the indicated problems were themselves appreciated in the art. While the described principles can, in some aspects and embodiments, alleviate the problems inherent in other approaches, it will be appreciated that the scope of the protected innovation is defined by the attached claims, and not by the ability of any disclosed feature to solve any specific problem noted herein.

### SUMMARY

The disclosure, in one aspect, provides a dry, flowable beverage composition. The beverage composition includes a tea mixture, the tea mixture including between about 60 percent and about 90 percent by weight of non-matcha tea and between about 10 percent and about 45 percent by weight of matcha tea. The non-matcha tea comprises a soluble, powdered tea extract. The beverage composition is substantially free of fillers.

In another aspect, the disclosure provides a system for producing a beverage. The system includes a dry, flowable beverage composition and a container. The beverage composition includes a soluble, powdered beverage extract. The container includes a body and a lid. The body defines an interior chamber. The beverage composition is disposed within the interior chamber of the body. The lid is mounted to the body such that the lid is movable between an open position and a closed position. The lid, when in the closed position, prevents the beverage composition disposed within the interior chamber of the body from being dispensed therefrom. The lid, when in the open position, permits the beverage composition disposed within the interior chamber of the body to be dispensed therefrom. The body and the lid of the container are both made from metal.

In yet another aspect of the disclosure a method of producing a beverage is provided including disposing a supply of a dry, flowable beverage composition in an interior chamber defined by a body, the beverage composition including a soluble, powdered beverage extract. A lid is removably mounted to the body. The lid includes an inner shell and an outer shell. The outer shell is rotatably connected to the inner shell about a rotation axis, the inner shell and the outer shell each defining at least one opening. The outer shell is positioned about the rotation axis with respect to the inner shell in an open position such that at least one opening of the outer shell is aligned with at least one opening of the inner shell such that the inner cavity is in communication with the exterior of the container via the aligned openings. An amount of the beverage composition is dispensed from the interior chamber of the body via the aligned openings of the lid into water held in a cup.

Further and alternative aspects and features of the disclosed principles will be appreciated from the following detailed description and the accompanying drawings. As will be appreciated, seal rings for a seal assembly, seal assemblies, and methods of preparing a seal ring for a seal assembly disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a perspective view of an embodiment of a container shaped and sized to contain and dispense powdered tea compositions according to principles of the present disclosure.

FIG. 2 is a cross sectional view of the container of FIG. 1 with an enlarged detail view thereof.

FIG. 3 is an interior view of a lid of the container of FIG. 1.

FIG. 4 is a side elevational view of an embodiment of a refill container for containing powdered tea compositions according to the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

Beverage compositions according to the present disclosure are in the form of an instant and/or powdered tea product. In embodiments, a powdered beverage composition following principles of the present disclosure can include a soluble powdered beverage extract and optionally, one or more natural flavorings and/or other flavor adjuncts. In embodiments, a powdered beverage composition following principles of the present disclosure is substantially free of fillers, bulking agents, and/or non-natural ingredients. In embodiments, the constituent ingredients of a powdered beverage composition following principles of the present disclosure are all natural. In embodiments, the constituent ingredients of a powdered beverage composition following principles of the present disclosure are organic certified under the National Organic Program or derived from organic sources and organically grown products.

In embodiments, a dry, flowable beverage composition following principles of the present disclosure can include a tea mixture. The tea mixture can include between about 60 percent and about 90 percent by weight of non-matcha tea and between about 10 percent and about 45 percent by weight of matcha tea. In embodiments, the non-matcha tea comprises a soluble, powdered tea extract. In embodiments, the beverage composition is substantially free of fillers.

In embodiments of a beverage composition following principles of the present disclosure, the beverage composition can include matcha. Matcha is a finely ground powder of specially grown and processed green tea as will be readily understood by one skilled in the art. It is special in two aspects of farming and processing: The green tea plants for matcha are shade-grown for about three weeks before harvest, and the stems and veins are removed in processing. In embodiments, the beverage composition includes an amount of matcha sufficient for the matcha to act as a natural flow agent, which can help avoid the use of non-natural flow agents in the beverage composition.

Matcha of a quality suitable for traditional tea ceremonies is referred to as ceremonial-grade matcha. Matcha of lesser quality is often used in confections and other food products. Blends of matcha are given poetic names known as chamei (“tea names”) by the producing plantation, shop, or creator of the blend, or, by the grand master of a particular tea tradition. When a blend is named by the grand master of a tea ceremony lineage, it becomes known as the master's konomi, or favored blend.

In embodiments of a beverage composition following principles of the present disclosure, the beverage composition can include a “non-matcha” tea, which contemplates any type of tea that is not considered matcha. Tea is generally divided into categories based on how it is processed. In embodiments, the beverage composition can include any suitable non-matcha tea. For example, in embodiments, the non-matcha tea can comprise at least one of the following six different types of non-matcha tea: (1) “white,” which is wilted and unoxidized; (2) “yellow,” which is unwilted and unoxidized, but allowed to yellow; (3) “green,” which is unwilted and unoxidized; (4) “oolong,” which is wilted, bruised, and partially oxidized; (5) “black,” which is wilted, sometimes crushed, and fully oxidized; (6) “red,” which is also referred to as rooibos tea and is an herb acquired from the Aspalathus linearis bush plant typically in South Africa; and (7) “post-fermented,” which is green tea that has been allowed to ferment/compost.

In embodiments, the non-matcha tea comprises a soluble, powdered tea extract. The tea extract can be made using any suitable technique known to those skilled in the art. For example, instant powdered black tea can be prepared by taking fresh green leaves of the plant Camellia sinensis and permitting them to wither. Withering is a process where plucked tealeaves are allowed to lose moisture and bring about chemical/biochemical changes especially in aroma. The tealeaves are macerated and fermented, wherein the tealeaf is exposed to atmospheric oxygen. The resulting material is dried at temperatures sufficient to stop enzymatic activities and then reduced to a powder. In yet other embodiments, other types of instant powdered non-matcha tea extract can be prepared according to well-known methods and comprise a part of a beverage composition following principles of the present disclosure.

In embodiments of a beverage composition following principles of the present disclosure, the beverage composition includes a tea mixture having between about 60 percent and about 90 percent by weight of non-matcha tea and between about 10 percent and about 45 percent by weight of matcha tea. In embodiments, the tea mixture of the beverage composition can include matcha tea in an amount from about 20 percent to about 30 percent by weight of the tea mixture. In other embodiments, the tea mixture of the beverage composition can include matcha tea in an amount of about 25 percent by weight of the tea mixture.

In embodiments of a beverage composition following principles of the present disclosure, the beverage composition can include a natural flavor additive. In embodiments, the beverage composition can include more than one natural flavor additive. In embodiments, the natural flavor additive comprises flavoring constituents derived from at least one fruit or fruit juice. In embodiments, the natural flavor additive comprises at least one of blueberry flavor, plum flavor, chai flavor, mango flavor, kiwi flavor, peach flavor, and orange flavor.

Flavorings contemplated for use in a beverage composition following principles of the present disclosure include fruit, fruit flavorings, extracts, fruit juice, and/or other natural flavor compositions. For example, compositions according to various embodiments can include one or more of natural blueberry flavor, natural plum flavor, natural chai flavor, natural mango flavor, natural kiwi flavor, natural peach flavor, natural orange flavor and the like. In embodiments, the beverage composition can include other flavorings, such as mint flavorings, natural herbal extracts and natural floral extracts and the like.

In embodiments, a natural flavor additive can comprise essential oil, oleoresin, essence or extractive, protein hydrolysate, distillate, or any product of roasting, heating or enzymolysis, which contains the flavoring constituents derived from one or more of a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional. In embodiments, a natural flavor additive can include the natural essence or extractives obtained from one or more suitable plants.

In embodiments, a powdered beverage composition following principles of the present disclosure includes substantially only natural ingredients. In embodiments, the powdered beverage composition is substantially free of fillers, bulking agents, and/or non-natural ingredients. In embodiments, the constituent ingredients of a powdered beverage composition following principles of the present disclosure are all natural. In embodiments, at least one of the constituent ingredients of the powdered beverage composition is organic certified under the National Organic Program or derived from organic sources and organically grown products. In embodiments, all of the constituent ingredients of the powdered beverage composition are organic certified under the National Organic Program or derived from organic sources and organically grown products.

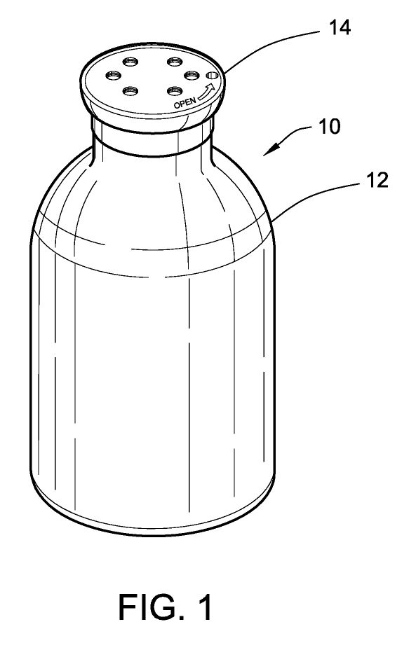

Referring now to FIGS. 1-3, in embodiments, a system for producing a beverage constructed according to principles of the present disclosure includes a refillable container 10 configured to store and to dispense powdered beverage compositions, some examples of such compositions being provided herein. The container includes a body 12 and a lid 14. The body defines an interior chamber 16. The beverage composition can be disposed within the interior chamber 16 of the body 12.

In embodiments, the lid 14 is mounted to the body 12 such that the lid 14 is movable between an open position and a closed position. The lid 14, when in the closed position, prevents the beverage composition disposed within the interior chamber 16 of the body 12 from being dispensed therefrom. The lid 14, when in the open position, permits the beverage composition disposed within the interior chamber 16 of the body 12 to be dispensed therefrom.

In embodiments, the lid 14 includes at least a portion that is rotatably movable between the closed position and the open position. In the illustrated embodiment, the lid 14 is removably mounted to the body 12. The lid includes an inner shell 18 and an outer shell 20. The outer shell 20 is rotatably connected to the inner shell 18 about a rotation axis 22. The inner shell and the outer shell each define at least one opening 24 formed therethrough. The outer shell is rotatable about the rotation axis 22 with respect to the inner shell 18 over a range of travel between a closed position and an open position. The openings 24 of the inner shell 18 and outer shell 20 are offset from each other when the outer shell is in the closed position. At least one opening 24 of the outer shell 20 is aligned with at least one opening 24 of the inner shell 18 such that the inner chamber is in communication with the exterior of the container via the aligned openings when the outer shell is in the open position.

A dry, flowable beverage composition can be provided that includes a soluble, powdered beverage extract. The beverage composition can be disposed within the interior chamber 16 of the body 12. In embodiments, the soluble, powdered beverage extract of the beverage composition comprises at least one of an instant coffee powder and a powdered non-matcha tea extract. In embodiments, a system for producing a beverage constructed according to principles of the present disclosure can be used with any powdered beverage composition according to principles of the present disclosure.

The body 12 can be any suitable shape and size. In the illustrated example, the body 12 is sized to contain from about 40 to about 80½ teaspoon sized servings of tea compositions according to the present disclosure. Preferably, the body 12 is sized to contain about 60½ teaspoon sized servings.

In embodiments, the body 12 and the lid 14 of the container 10 are both made from metal. In embodiments, the body 12 and the lid 14 of the container 10 can be made from any suitable metal, including a suitable metal alloy. In embodiments, the body 12 and the lid 14 can be made from different metals. In embodiments, the body 12 and the lid 14 of the container 10 are both made from a metal that is recyclable and food safe. In one example, the body 12 and the lid 14 of the container 10 are both made from aluminum, which is strong, food safe, attractive, washable, reusable, and recyclable.

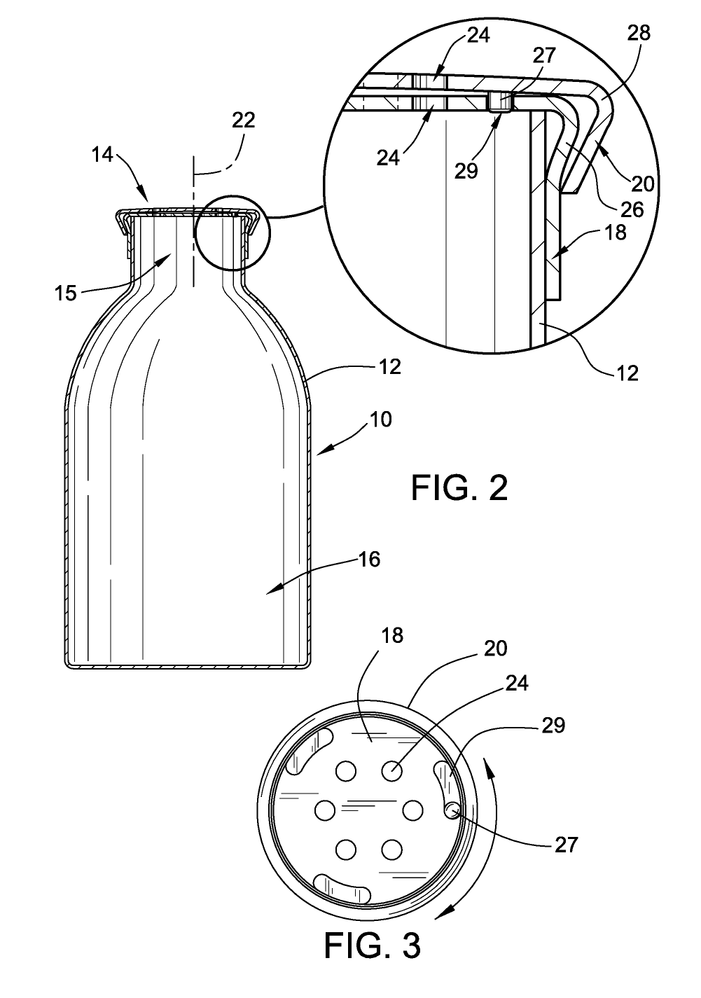

Turning to FIG. 2, the inner shell 18 is releasably attachable to the body 12 by, for example, a friction fit as shown, or alternatively by a threaded engagement, or by any other suitable removable attachment construction. Also, the container body 12 preferably includes a wide opening 15 for refilling.

The outer shell 20 stays connected to the inner shell 18 by way of a retaining feature 26. The retaining feature 26 can be in the form of a bead formed on the outer periphery of the interior portion in combination with a capture feature 28, in the form of a turned down edge, for example, formed on the periphery of the exterior portion in the vicinity of the bead. Both the inner shell 18 and the outer shell 20 each have at least one opening 24 formed therethrough that, when aligned, permit the flow through of material residing in the interior chamber of the body 12. When the openings 24 are not aligned material is prevented from being dispensed from the container 10 and retained therein. Also, ingress of foreign material is prevented when the openings 24 are not aligned.

The outer shell 20 and the inner shell 18 of the lid 14 include a pair of mating first and second detent surfaces 27, 29, respectively, the first and second detent surfaces positioned to retentively engage each other when the outer shell is disposed in the closed position. The first detent surface 27 of the outer shell 20 can include a protrusion, and the second detent surface 29 of the inner shell 18 can define a slot, which includes a closed position end and an open position end. With the protrusion 27 of the outer shell 20 disposed within the slot 29, the closed position end and the open position end are interferingly arranged with respect to the protrusion to limit the range of travel of the outer shell about the rotation axis 22 with respect to the inner shell 18 between the closed position and the open position, respectively.

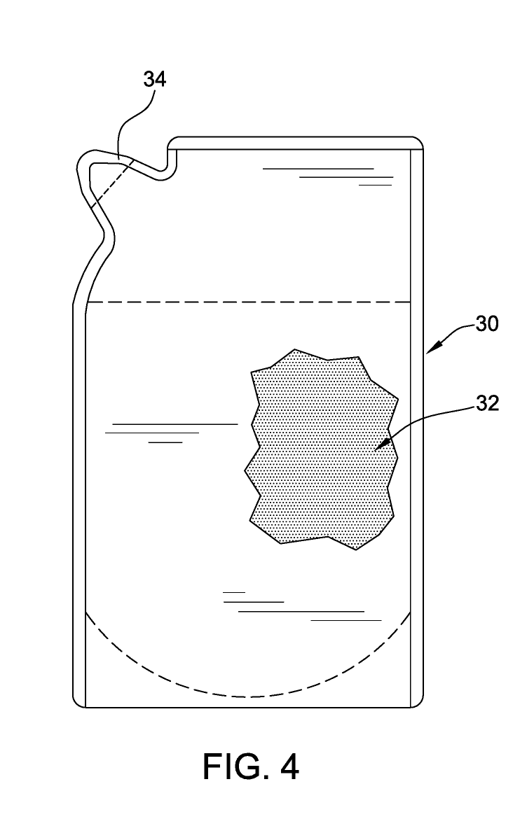

Referring to FIG. 4, a system for producing a beverage constructed according to principles of the present disclosure can an embodiment of a refill container 30, such as the one shown in FIG. 4, for example. The illustrated refill container is in the form of a pouch configured to store therein a powdered beverage composition 32 according to principles of the present disclosure. In the illustrated embodiment, the refill container 30 includes a pour spout 34 formed at a corner thereof, which when severed provides a convenient structure to direct powdered beverage composition into the opening 15 of the container body 12 and prevent spillage when refilling the container 10. In embodiments, the refill container 30 can be any suitable size and shape and can be made from any suitable material, for example, food grade plastic and/or metallic/foil materials. Preferably, the refill container 30 is made from a material that prohibits the entry of oxygen and moisture to enable a stable shelf life and freshness of the ingredients kept within.

The present disclosure contemplates a system for producing a beverage including the container 10 and the refill container 30. The system can include a powdered beverage composition according to principles of the present disclosure provided in the container 10, the refill container 30, or both.

In use, and referring to the figures, the disclosure contemplates a method of producing a beverage, the method including disposing a supply of a dry, flowable beverage composition in an interior chamber 16 defined by a body 12, the beverage composition including a soluble, powdered beverage extract. A lid 14 is removably mounted to the body 12, the lid including an inner shell 18 and an outer shell 20, the outer shell being rotatably connected to the inner shell about a rotation axis 22. The inner shell 18 and the outer shell 20 each define at least one opening 24. The outer shell 20 is positioned about the rotation axis 22 with respect to the inner shell 18 in an open position such that at least one opening 24 of the outer shell is aligned with at least one opening 24 of the inner shell. The inner cavity 16 is thus provided in communication with the exterior of the container 12 via the aligned openings. An amount of the beverage composition is dispensed from the interior chamber 16 of the body 12 via the aligned openings 24 of the lid 14 into water held in a cup.

The method can further include rotating the outer shell 20 about the rotation axis 22 with respect to the inner shell 18 from the open position to a closed position, the openings 24 of the inner shell and outer shell being offset from each other when the outer shell is in the closed position. Further, the method can include removing the lid 14 from the body 12, refilling the body by adding a refill amount of the beverage composition into the interior chamber 16 defined by the body, and after refilling, removably mounting the lid to the body. In yet another aspect, the method can include the lid 14 being removably mounted to the body 12 via a friction fit therebetween.

In use, a system for producing a beverage constructed according to principles of the present disclosure can be used by filling the container 10 with a powdered beverage composition. The powdered beverage composition is stored within the container 10, and, when desired, dispensed therefrom in amounts suitable for preparing a beverage in a selected volume of heated, chilled or room temperature water. A consumer can add a desired amount of a powdered beverage composition constructed according to principles of the present disclosure to water in order to produce a beverage.

In embodiments, the powdered beverage composition includes a soluble powdered beverage extract that can dissolve in the water to produce a ready-to-drink beverage. In embodiments, the powdered beverage composition includes matcha in an amount suitable for it to act as a natural flow agent. In embodiments, a powdered beverage composition constructed according to principles of the present disclosure can be used with hot water to produce a hot beverage. In embodiments, hot water refers to water at a temperature in the range of 60 to 100° C. However, in embodiments, a powdered beverage composition constructed according to principles of the present disclosure can be used to produce cold or iced beverages, as well.

When the powdered beverage composition stored in the container becomes low or is consumed, the container 10 can be refilled from a refill container 30. Preferably, the container 10 is cleaned and/or sanitized before reuse. The container 10 can be reused according to the above method any number of times, realizing a cost savings and creating less waste.

### EXAMPLES

### Example 1

A dry, free-flowing beverage composition is formulated such that it includes a tea mixture comprising organic green tea in powder form and organic matcha tea in powder form.

### Example 2

A dry free-flowing beverage composition is formulated such that it includes a powdered beverage extract comprising a tea mixture of black tea extract and organic matcha tea in powder form and a natural flavor additive comprising non-GMO natural chai flavor.

### Example 3

A dry free-flowing beverage composition is formulated such that it includes a powdered beverage extract comprising red, or rooibos, tea extract and a natural flavor additive comprising a mixture of non-GMO natural plum flavor and natural blueberry flavor in powder form.

### Example 4

A dry free-flowing beverage composition is formulated such that it includes a powdered beverage extract comprising a tea mixture of green tea extract and matcha tea in powder form and a flavor additive comprising a mixture of non-GMO natural kiwi flavor, non-GMO natural peach flavor, and natural mango flavor.

Any of the above examples can be combined with or added to full-leaf tea. The consumer can add other additives, e.g. sugar, milk, honey, or the like to taste.

It will be appreciated that the foregoing description provides examples of the disclosed devices, compositions and/or methods. However, it is contemplated that other implementations of the disclosure can differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A dry, flowable beverage composition, the beverage composition comprising:
a tea mixture, the tea mixture including between about 60 percent and about 90 percent by weight of non-matcha tea and between about 10 percent and about 45 percent by weight of matcha tea;
wherein the non-matcha tea comprises a soluble, powdered tea extract;
wherein the beverage composition is substantially free of fillers.

2. The beverage composition of claim 1, wherein the non-matcha tea comprises at least one of white tea, yellow tea, green tea, oolong tea, black tea, red tea, and post-fermented tea.

3. The beverage composition of claim 1, wherein the matcha tea is in an amount from about 20 percent to about 30 percent by weight of the tea mixture.

4. The beverage composition of claim 1, further comprising:
a natural flavor additive.

5. The beverage composition of claim 4, wherein the natural flavor additive comprises flavoring constituents derived from at least one fruit or fruit juice.

6. The beverage composition of claim 4, wherein the natural flavor additive comprises at least one of blueberry flavor, plum flavor, chai flavor, mango flavor, kiwi flavor, peach flavor, and orange flavor.

7. A system for producing a beverage, the system comprising:
a dry, flowable beverage composition, the beverage composition including a soluble, powdered beverage extract;
a container, the container including a body and a lid, the body defining an interior chamber, the beverage composition disposed within the interior chamber of the body, the lid mounted to the body such that the lid is movable between an open position and a closed position, the lid when in the closed position preventing the beverage composition disposed within the interior chamber of the body from being dispensed therefrom, and the lid when in the open position permitting the beverage composition disposed within the interior chamber of the body to be dispensed therefrom, and wherein the body and the lid of the container are both made from metal.

8. The system according to claim 7, wherein the lid is removably mounted to the body via a friction fit therebetween.

9. The system according to claim 7, wherein the lid includes at least a portion that is rotatably movable between the closed position and the open position.

10. The system according to claim 7, wherein the lid includes an inner shell and an outer shell, the outer shell being rotatably connected to the inner shell about a rotation axis, the inner shell and the outer shell each defining at least one opening, the outer shell being rotatable about the rotation axis with respect to the inner shell over a range of travel between a closed position and an open position, the openings of the inner shell and outer shell being offset from each other when the outer shell is in the closed position, and at least one opening of the outer shell being aligned with at least one opening of the inner shell such that the interior chamber is in communication with the exterior of the container via the aligned openings when the outer shell is in the open position.

11. The system according to claim 10, wherein the outer shell includes a detent feature and the inner shell of the lid include a pair of mating first and second detent surfaces, respectively, the first and second detent surfaces positioned to retentively engage each other when the outer shell is disposed in the closed position.

12. The system according to claim 10, wherein the first detent surface of the outer shell comprises a protrusion, and the second detent surface of the inner shell defines a slot and includes a closed position end and an open position end, the protrusion of the outer shell disposed within the slot, the closed position end and the open position end interferingly arranged with respect to the protrusion to limit the range of travel of the outer shell about the rotation axis with respect to the inner shell between the closed position and the open position, respectively.

13. The system according to claim 7, wherein the soluble, powdered beverage extract of the beverage composition comprises at least one of an instant coffee powder and a powdered non-matcha tea extract.

14. The system according to claim 7, wherein the soluble, powdered beverage extract of the beverage composition comprises a powdered non-matcha tea extract, the beverage composition including a tea mixture, the tea mixture including between about 60 percent and about 90 percent by weight of the powdered non-matcha tea extract and between about 10 percent and about 45 percent by weight of matcha tea, and wherein the beverage composition is substantially free of fillers.

15. The system according to claim 14, wherein the beverage composition includes a natural flavor additive.

16. The system according to claim 7, further comprising:
a refill container configured to store a second supply of the beverage composition.

17. A method of producing a beverage, the method comprising:
disposing a supply of a dry, flowable beverage composition in an interior chamber defined by a body, the beverage composition including a soluble, powdered beverage extract;
removably mounting a lid to the body, the lid including an inner shell and an outer shell, the outer shell being rotatably connected to the inner shell about a rotation axis, the inner shell and the outer shell each defining at least one opening;
positioning the outer shell about the rotation axis with respect to the inner shell in an open position such that at least one opening of the outer shell being aligned with at least one opening of the inner shell such that the inner cavity is in communication with the exterior of the container via the aligned openings;
dispensing an amount of the beverage composition from the interior chamber of the body via the aligned openings of the lid into water held in a cup.

18. The method according to claim 17, further comprising:
rotating the outer shell about the rotation axis with respect to the inner shell from the open position to a closed position, the openings of the inner shell and outer shell being offset from each other when the outer shell is in the closed position.

19. The method according to claim 17, further comprising:
removing the lid from the body;
refilling the body by adding a refill amount of the beverage composition into the interior chamber defined of the body;
after refilling the body, removably mounting the lid to the body.

20. The method according to claim 19, wherein the lid is removably mounted to the body via a friction fit therebetween.
